(19) United States
(12) Patent Application Publication
(10) Pub. No.: US 2003/0038517 A1
(43) Pub. Date: Feb. 27, 2003

(54) Health and comfort support system including common application

(76) Inventors: Scott J. Moran, East Greenwich, RI (US); Ryan K Weeks, Royal Oak, MI (US)

Correspondence Address: Eric T Jones, Reising Ethington Barnes, Kisselle Learman & McCulloch, PO Box 4390, Troy, MI, 48099-4390, US

(21) Appl. No.: 10/088,761

(22) PCT Filed: Nov. 30, 2000
(86) PCT No.: PCT/US00/42417

(51) Int. Cl. B60N 2/44

(52) U.S. Cl. 297/284.3; 297/284.6; 297/452.41

(57) ABSTRACT

A vehicle seat arrangement having a plurality of air cells therein for supporting a user including a plurality of air cells (100) with expandable chambers comprising a fixed array; a controller (110) for connecting said plurality of air cells and a fluid supply system that includes fittings for cutting off one or more of the air cells from the controller to conform the fixed array of air cells to one of a plurality of vehicle types (100, 112, 118).

### FIELD OF THE INVENTION

This invention relates to vehicle or chair seating or bed support configurations comprised of inflatable air cells for controlling the contour of the supporting inflatable cells to produce selective body support or body massage.

### BACKGROUND OF THE INVENTION

Inflatable air cells have been used in a variety of configurations to provide pressure adjustments so as to produce a body support of an occupant supported by those inflatable air cells. This is especially important in automobiles where long periods of driving can cause pain and distraction or in other seating applications (for instance, airlines) where individuals are sedentary for long periods of time.

Prior art systems have not included a system wherein an array of air cells has the ability to outfit a seat of a certain design with air cells in multiple locations that can be installed and activated to suity the preferences of a particular vehicle type, e.g., SUVs, luxury vehicles or sport vehicles to name a few. The choice of what cells are operated to selectively meet the requirements of different vehicle types can be made when the vehicle is built, when the vehicle is at the dealer or as an after market feature. If desired the matching to a vehicle type can be made by the user by a switch function. Thus, by use of a common control module and selected arrays of air cells, a wide range of comfort and support effects are obtained that as a modular pneumatic seating system meets a variety of seating objectives. Such seating systems can be configured individually or can be provided as a generic multi-celled system that can be installed in all vehicle seat types and wherein the choice of which cells to actuate is accomplished at a dealership to meet customer choices at the dealership (mass customization). Air cell locations can include one or more of air cell locations including head rest; upper back; lumbar; back bolsters; seat bolsters; seat isial support; thigh; and calf and can include air cell groups of from 2 cell to 5 cell.

Another feature not found in the prior art is a system wherein a modular unit of air cells is provided with a fixed array of air cells, a pump, connecting tubes, and a wiring harness and wherein the wiring harness is then connected to one of a plurality of controller types to provide different types of control for the array including a controller type that only provides basis occupant support; a controller type that provides health operation and a controller type that can provide both support and massage to name a few. The kind of cells in the basic array can be based on a combination of cells installed and used in a particular vehicle type or to obtain a particular user preference for obtaining comfort and a healthy seating experience.

Prior art seating systems including body massage are set-forth in U.S. Pat. Nos. 4,655,505; 5,135,282; 5,587,933 wherein inflatable air cells are provided to adjust the pressure in the air cells to produce a massage action on an occupant of a support surface. In the '505 patent the only type of massage mentioned incorporates changes in the support pressure within each cell.

In the '282 patent a sequential control of air cell pressure includes a sequential pressurization of each of the cells forming the back support for a supporting surface and a sequential deflation. However, in this system one after another of the cells are first inflated and then one after another cells are deflated. The result is a broad wave front type of massage.

In the '933 patent an interactive control is provided to produce a cyclical massage at a given body part.

U.S. Pat. No. 4,981,131 includes a fluid inflatable bag that is configured to move a spine through a range of lordosis and the pressure in the bag is controlled by a regulator that alternately causes inflation and deflation of the bag and wherein the regulator comprises pressure relief valves that cooperate with a timer that operates solenoid valves to control pressures within the limits of the relief valves.

While suitable for their intended purpose, the various known vehicle seat systems with inflatable air cells for contour shaping of the vehicle seat surface to enhance comfort do not provide a system that is can be suited to a vehicle type or modularized and then controlled to a particular vehicle type.

### SUMMARY OF THE INVENTION

A feature of the invention is to provide a multiple air cell arrangement providing both ergonomic lumbar support and surface movement can be configured to provide both health and comfort air cell units and can be configured for filling various requirements of vehicle types.

A further feature is to provide such systems wherein an air cell array can be provided to meet one or more vehicle type requirements and where in the choice of which air cells to activate can be made at a dealership through amass customization.

A still further feature is to provide a seating module and controller that can provide bundled control module and air cell zone combinations including 2-zone combinations having seat S2/L5 air cell combinations; I/L5/3 air cell combinations; seat S2/SBB air cell combinations; I/seat S2 air cell combinations; L5/3/SBB combinations; I/SBB; I/CBB; RT/LT. Three zone combinations can include (S2,L5,L3); (S22, L5/3. SBB); (L5/3,SBB,I); L5/3,SBB,CBB); (I,RT,LT);(I,SBB,CBB); (RT,LT,CBB). Four zone combinations can include (S2,L5,L3,SBB); (S2,L5/3,SBB,CBB); (S2, L5/3,LT,RT); (I, LT,RT,L5/3) and(I,LT,RT,S2).

Codes for each of the aforedescribed air cell zone and combinations are as follows:

I—Ischial

SBB—Seat back bolster side air cells

CBB—Cushion bolster side air cells

RT—Right thigh support air cell

LT—Left thigh support air cell

S2—Iliac support air cell

L5—Lower lumbar support air cell

L3—Middle lumbar support air cell

The packaging of such air cells and control module enables the supplier to control the function and operational packages on a health and performance basis based upon desired objectives that they are designed to satisfy. Thus, air cells positioned to support the ischial and lumbar and seat iliac of a user can satisfy health features including posture and circulation; bolster and seat features can satisfy high performance vehicle seating requirements; and seat and thigh support features can satisfy comfort requirements. Combinations of health, comfort and performance are also possible.

More particularly a system is configured to provide both support of an occupant for seating comfort or to improve user health by spinal and pelvic adjustments.

The invention includes one or more air cells preferably located in a seat back but suitable for use in other locations of an occupant support system. In one embodiment the air cells are three in number with each cell connected to a separate vent (bleed) valve and to a separate fill valve to allow for simultaneous inflation and deflation of each of the cells.

In addition to the posture-establishing ergonomic control function of the three air cells, they are associated with a controller that includes a circuit board with a plurality of switches for selectively controlling the operation of a microprocessor to initiate either manual pressure control of the air cells or to initiate a massage action.

An automatic massage control is initiated by a microprocessor in response to control signals from a combination of manual control switch techniques as follows:

| | |
|---|---|
| Technique 1 | Single, momentary, push-button switch with a toggle |
| | function. Pushing switch once initiates massage, pushing |
| | switch a second time halts massage. |
| Technique 2 | Two position, momentary rocker switch. Pushing one side |
| | of switch turns massage on and pushing the other side of |
| | the switch turns massage off. |
| Technique 3 | Embedded switch function: pressing two switches at one |
| | time initiates massage and pressing the opposite two |
| | switches halts massage, e.g., press inflate zone 1 and inflate |
| | zone 2 simultaneously to start massage and press deflate |
| | zone 1 and deflate zone 2 simultaneously to halt massage. |

In all cases, when massage is halted, either through timing out or by the user selecting the proper switch(es), the system performs a deflate all and then inflates the support zones to their setting before massage is initiated. When massage is initiated, all zones are deflated before the actual massage sequence begins.

For massage intensity, a two-position momentary rocker switch is used. The options are to increase or decrease massage intensity. Increasing massage intensity, increases the inflation/deflation time to increase the resulting pressure in the cells but also slows the progress from one cell to the next. Decreasing massage intensity, decreases the inflation/deflation time to decrease the resulting pressure in the cells and also speeds the progress from one cell to the next. The speed impact is a byproduct of the intensity changes while the pressure increase/decrease is the goal of the change.

The automatic massage sequence can embody various options, versions, modes provided by a microprocessor program that will selectively operate the fill and vent valve of each air cell to inflate and exhaust the multiple air cells in a stepped fashion at a fill and exhaust period for each air cell in a range for producing a rapid pulse of each of the air cell surfaces in sequence. The fill and exhaust periods are application specific and depend on the size (volume) of the cells, the length of the hoses and the cell position relative to the seat surface. As currently configured, the time's range from 0.25 second to 5 seconds. However, the maximum time may be increased for other applications, e.g., home seating.

A system of inflatable air cells is constructed and installed in a seat at locations which are strategic to the comfort of the user. The air cells are connected to a pump through a feed manifold and valve arrangement. In one embodiment, the valve arrangement can include a dual valve for each air cell comprising a fill valve and a vent valve for each air cell to simultaneously or sequentially, as desired, connect each cell to the pump while simultaneously exhausting one or more of the cells to a vent. The dual valve arrangement controls the flow of fluid in the air cell distribution system to produce rapid individual cell to cell pulse or a rapid individual cell to cell wave action wherein the massage movement includes a microprocessor program controlled sequence of inflate and deflate between the respective cells so as to provide a rapid concentrated massage action. The automatic control of the air cell pressures eliminates the need for a feedback function such as the use of pressure transducers for indicating full inflation or deflation of the air cells. Rather target pressures are attained using a programmed time of inflation or deflation of the air cells as established by desired program sequences of operation by a microprocessor.

A microcomputer's non-volatile memory is programmed with data representing a desired massage type and level for the air cells. By sequentially activating each set of dual valves and energizing the pump motor for predetermined periods, and by varying the number and location of the cells the system is time responsive to produce rapidly adjusted localized pressures exerted on the body for a great variety of uses. Additionally, in accordance with the present invention, air cells forming the contouring elements of the seat back and seat bottom have their pressure controlled at a frequency that will produce the desired massage effect.

One feature of the present invention is to provide the system of the preceding objects wherein the control sequence is under a microcomputer control and wherein a manual inflate or deflate control is established by inputting the microcomputer with input signals from manually operated inflate or deflate switches and wherein the microcomputer is preprogrammed to provide a timed inflate and exhaust of the air cells.

A further feature of the present invention is to provide the system of the preceding object wherein the massage control sequence is under a microcomputer control and wherein an automatic control sequence is established by input signals from manually operated inflate or deflate switches and wherein the microcomputer is preprogrammed to provide a timed inflate and exhaust of the air cells.

A preferred embodiment utilizes three to four cells in the lumbar area to set an optimal pelvic angle and provide support for the spine and then flex the spine to exercise (pump out waste materials).

### BRIEF DESCRIPTION OF THE DRAWINGS

FIG. 1 is a perspective view of an automotive seat showing a one embodiment of the invention for locating pneumatic massage air cells in the seat back, seat and head rest positions of a vehicle seat structure.

FIG. 2 is a view of a pressure supply system for the embodiment of FIG. 1;

FIGS. 3-5 are control components for the massage operating system for the embodiment of FIG. 1;

FIG. 6 is a view of another pressure supply system;

FIG. 7 is a view of a seat with air cells adaptable for different support and comfort combinations; and

FIG. 8 is a view of a modular pneumatic seating system of the present invention.

### DESCRIPTION OF THE PREFERRED EMBODIMENTS

The Seat

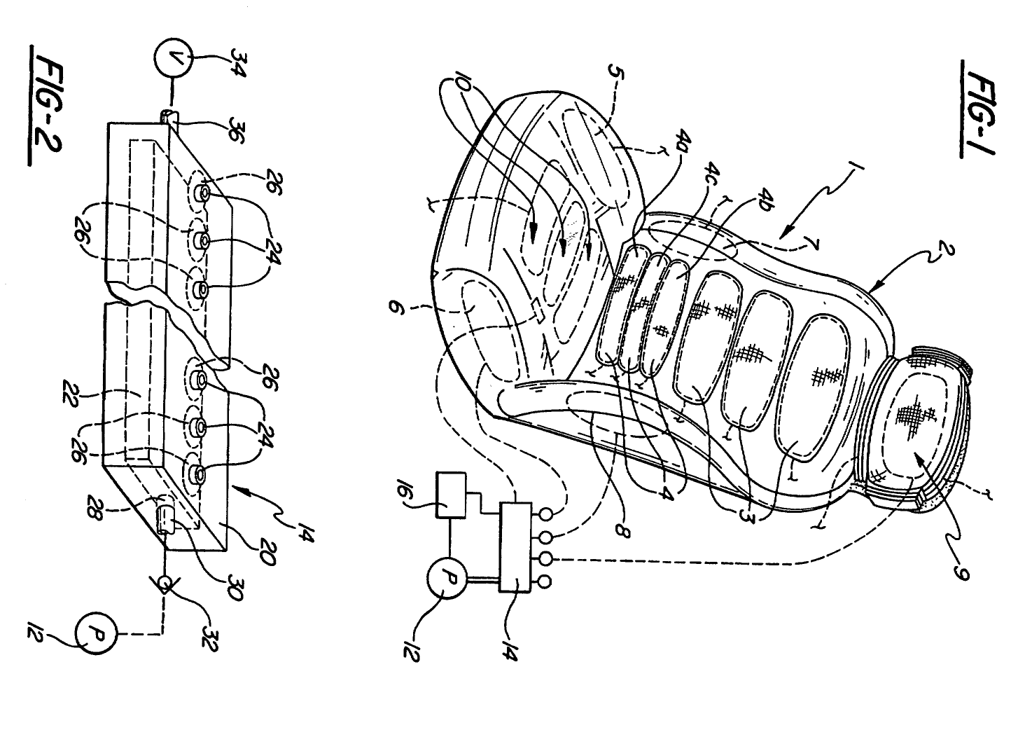

A series of air cells or bladders 1 are placed at strategic locations about the contour of an automotive seat 2 as shown in FIG. 1. The air cell placement is selected to coincide with key pressure points on the body of an occupant of the seat.

In particular, plural cells 3 are positioned in the thoracic region while plural cells 4 are combined in the lumbar region. To further facilitate the adjustment of the seat, pairs of cells 5, 6, 7 and 8 are positioned at either side of the back and seat as well as the front and back of the thighs respectively. Each of these cells is in direct contact with the body to provide the control system with information which may be related to the comfort of the user and in accordance with this invention to provide a desired massage action. The air cells can be on a foam surface beneath a trim cover or behind a foam cushion to adjust contour or can be located within the cushion or in place of the cushion.

In addition to the pairs of cells that are provided to adjust the comfort of a user, in accordance with the present invention a plurality of air cells 9 are formed in the headrest and a plurality of air cell 10 are provided in the seat bottom.

The cells are connected to a source of pressurized fluid provided in part by a pump 12 through a manifold 14 as shown in FIG. 2. The manifold 14 and pump 12 are controlled by a microcomputer 16 in response to information stored in the microcomputer 16.

Each individual cell is constructed of a suitable flexible material such as rubber, thermoplastic polyurethane, coated fabric or any other material provided with a fluid tight connection to the manifold to provide a path for conducting fluid into and out of the cell. The cells may be connected individually to the manifold or jointly with other cells. Individual spaced parallel cells 3,4,9, 10, located for full body support and for full body massage if desired, are controlled in a manner to provide a concentrated pulse or wave action, the invention also contemplates use of a pressurizable mat in place thereof that includes segments that are pressure controlled to produce the massage action of the present invention.

In accordance with the present invention the air cells 4 include a lower air cell 4a, a top air cell 4b and a middle air cell 4c. The air cells 4b and 4c are arranged in the back of a vehicle seat to provide an ergonomic support and to position the spine of a user in a desired posture. The air cell 4c is arranged to provide a desired position when inflated to properly position the occupant's pelvic region with respect to the vehicle seat.

FIG. 8 is a graphic demonstrating the ability of such systems to meet the requirements of different vehicle types. The seat system indicated by reference numeral 100 is a seat with enhanced sporting performance and includes a pair of seat cushion side bolster air cells 102, 104 and a pair of seat back bolster air cells 106, 108. Additionally, the seat includes two lumbar air cells 106, 108. The cells of such a performance vehicle seat have the pressure levels therein controlled either manually or automatically to produce side support during high-speed maneuvers. Such control is provided by a common control module 110 of the types set-forth herein or in copending U.S. patent application No. 08/808,511 having a common assignee that is incorporated herein by reference. The control module 110 is programmed to cause the seat air cells to be adjusted according to the desired comfort, performance and or health benefits desired.

The seat system indicated by reference numeral 112 in FIG. 8, includes lumbar air cells 114, 116 and a seat air cell 117 for supporting the iliac region of a user. The pressure in air cells 114, 116 and 117 is controlled by control module 110 when connected thereto for providing touring comfort operation as might be desired in an SUV. The control module 110 is connected by tubing or hoses 110a to the air cells and includes a pump 110b and a wiring harness 110c that will be connected to a single control module 110d or if the system is fully modularized to one of a plurality of different types of schematically shown controller selection choices 110d-110g depending upon the control function selected.

The seat system indicated by reference numeral 118 in FIG. 8, includes multiple (3) lumbar air cells 119 that are operated to provided desired comfort ergonomics and massage in a luxury vehicle application in accordance with suitable preprogramming of the control module 110.

Thus, by use of a common control module 110 and selected arrays of air cells, a wide range of comfort and support effects are obtained that as a modular pneumatic seating system meets a variety of seating objectives. Such seating systems can be configured individually or can be provided as a generic multi-celled system that can be installed in all vehicle seat types and wherein the choice of which cells to actuate is accomplished at a dealership to meet customer choices at the dealership (mass customization). Air cell locations can include one or more of air cell locations including head rest; upper back; lumbar; back bolsters; seat bolsters; seat isial support; thigh; and calf and can include air cell groups of from 2 cell to 5 cell.

The Control

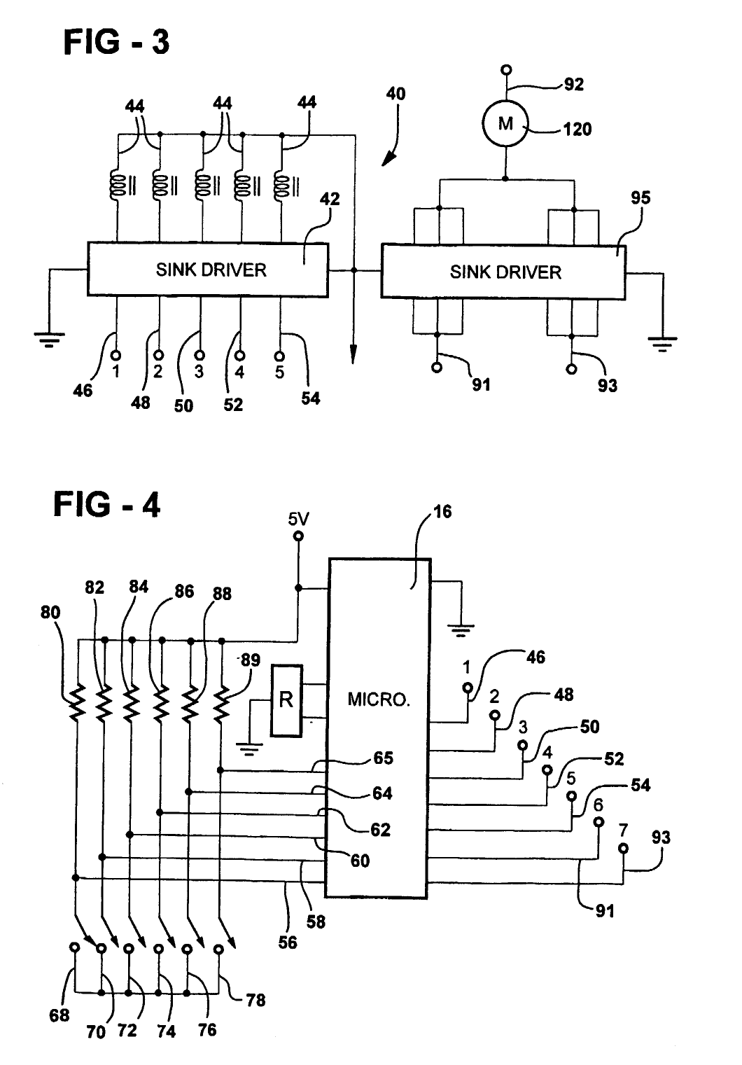

One suitable control circuit 40 is shown in FIG. 3 as including a valve drive 42 that is operative to connect valve solenoids 44 to a power source in response to signals on output signal lines 46-54 from the microcomputer 16. While solenoid operated valves are shown, they can be designed as low power, low fluid resistant operation. Such as highly efficient valves used in medical applications including MEMS type or piezoelectric actuated valves. The bodies and valve seats of such designs are easily moldable with and can be integrated as lightweight components within the manifold body. Individual valve bodies can be designed for stacking assembly to form the manifold of this invention. In addition to a piezoelectric actuated valve other low energy actuatable valves are contemplated by the present invention including but not limited to electrically pulsed reed valves; valves having an actuator configured of nickel titanium alloy such as Nitinol; magnetic inductive type valves or fluidic control valves so long as low energy consumption will operate the valve in on-off positions in which the flow from an inlet to outlet will satisfy the flow requirements of the pressure adjusted air cells in a given electropneumatic system for controlling a seating surface such as a seat, chair or bed to provide contouring, movement, support and/or comfort at a user interface. The importance of the use of such a valve arrangement in the present invention is that, in the past, pressure adjusted systems have utilized solenoid actuated valves to open and close an air cell to a pressure source for inflating the air cell or to a relief path for deflating the air cell. In such applications, the size of the control package is difficult to contain within the confines of a vehicle seat structure. Furthermore, power consumption is a problem since the major power consumers in the system combine power flow for operation of a motor driven pump and the power flow for operating the solenoids connected to the mechanical valving components.

The active parts of the system of this invention namely: the outlet valves, the pump 12, as well as bleed valve 34 and valves 26 are interconnected electrically to a microcomputer unit 16 which controls the operation of the system.

In order to operate each cell or group of cells independently to provide an extensively adjustable system, the MPU 16 must also be programmed to actuate the output valves to isolate a selected air cell or group of air cells in communication with the manifold. The MPU 16 can be a commercially available microcomputer. A microcomputer as used herein includes all subsystems and peripheral components as is well known to those skilled in the art.

The MPU 16 has access to non-volatile memory which has been programmed to provide a desired timed inflate, timed deflate or automatic timed massage control of the valves 26. This timed program sequence can be compiled and coded for use with individual air cells or regions of air cells.

In order to operate each cell or group of cells independently to provide an extensively adjustable system, the MPU 16 must also be programmed to actuate the output valves 26,44 to isolate a selected air cell or group of air cells in communication with the manifold.

Operation

The operation of the invention will be understood to have application to systems in which the air cells can be independently positioned or remain in a predetermined position on a support surface of a vehicle seat or the like.

In operation, the MPU 16 will open a valve 26, (126-130 in the embodiment of FIG. 6) interconnecting a selected air cell or air cell group, such as the back seat region cells 10, with the manifold chamber 22 and allow the pressure in the selected system to be set by the timing program of the microcomputer 16.

As shown in FIG. 4, the MPU 16 includes input signal lines 56-66 connected respectively to an upper air cell inflate switch 68, a lower air cell inflate switch 70, a middle or third air cell inflate switch 72, a upper air cell deflate switch 74, a lower air cell deflate switch 76, a middle or third air cell deflate switch 78. The switches are connected to pull-up resistors 80-89, respectively. When the switches are open a signal is directed to the microcomputer 16 that is greater than zero; when the switches are closed an input signal of zero volts is imposed on the microcomputer to initiate the various timed control sequences to produce either a full inflate of all the air cells 4a-4c or a full deflate thereof to desired max and min levels. The particular timed sequence will depend upon the particular switch signals directed to the input signal lines 56-66. Output line 91, 93 from the microcomputer 16 are connected to a motor driver 95 (shown in FIG. 3) for energizing and deenergizing the motor 12a for the pump 12. While exhaust is provided through an exhaust valve 34 the motor for the pump 12 can be deenergized by the preprogramming of the microcomputer 12 to direct a signal from output lines 91, 93.

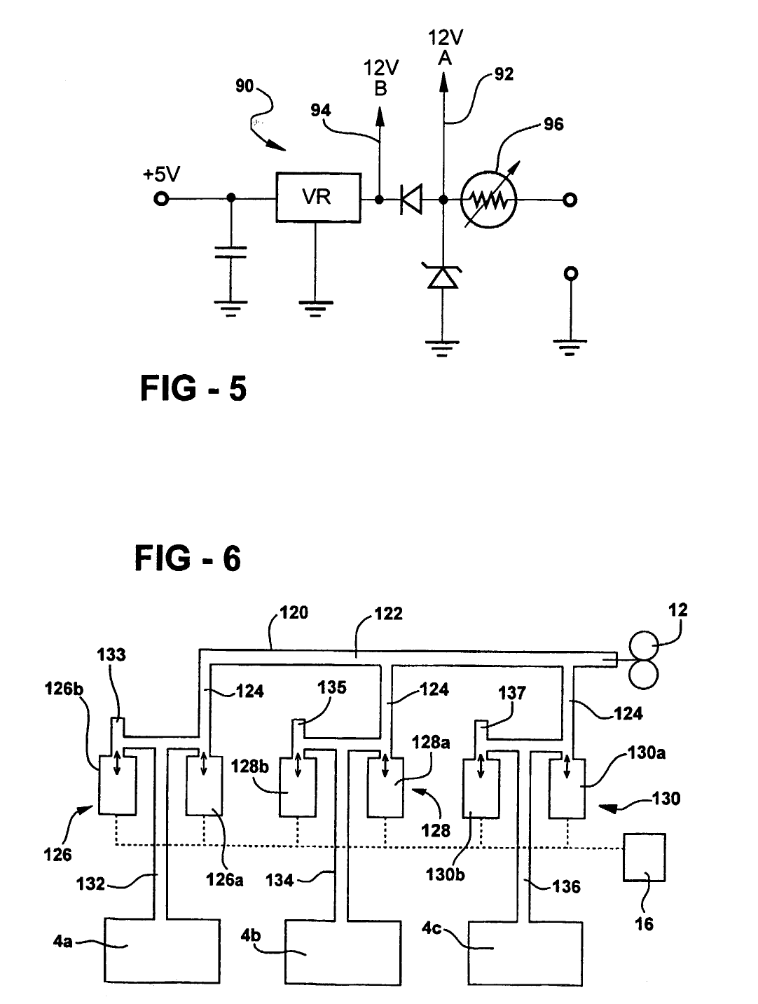

FIG. 5 is a protector circuit 90 that controls the voltage to a voltage source 92 for supplying power to the pump motor 12a. A diode protected voltage regulated voltage source 94 is provided. A PTC component 96 is provided to provide overload protection against excessive ambient or current draw operation.

The Dual Valve System

In another embodiment shown in FIG. 6, the manifold 14 consists of a housing 120 enclosing a chamber 122 constructed with multiple outlet ports 124 for connecting the chamber 122 to a set of dual valves 126, 128, 130. One set of dual valves is provided for each individual cell or regional group of cells 4a, 4b, 4c. Each dual valve 126, 128, 130 includes an outlet valve 126a, 128a, 130a for controlling the flow of fluid to an individual air cell through a supply/vent conduit 132, 134, 136, respectively. Each dual valve 126, 128, 130 has a vent or bleed valve 126b, 128b, 130b for exhausting an associated air cell through a vent conduit 133, 135, 137, respectively. Each conduit 132, 134, 136 serves as an air cell feed when its associated outlet valve 126a, 128a, 130a is opened and its associated vent valve 126b, 128b, 130b is closed. Conversely, each conduit serves 132, 134, 136 serves as an air cell vent when its associated vent valve 126b, 128b, 130b is opened and its associated outlet valve 126a, 128a, 130a is closed. The manifold can be molded of a high strength plastic material or other suitable material. The plastic material arrangement can have many of its components integrally molded therein. It is preferred that it be as compact and lightweight as possible. However, the invention can be configured with other than lightweight components and other than with integral components.

The active parts of the system of this invention namely: the outlet valves, the pump 12, as well dual valve sets 126, 128, 130 are interconnected electrically to a microcomputer unit 16 which controls the operation of the system.

Massage

The device and vehicle seat arrangement of this invention may be simplified by using a preset timed sequence as the programmed massage level and type and allowing the system to adjust the pressure in each air cell to produce the preselected massage by a selected operation of the suitable control switches. The only differences from the circuits shown in FIGS. 3-5 are the number of inputs/outputs available/used on the microcontroller. The embodiment illustrated in FIG. 6 uses six solenoids and so six outputs must be provided for them on the microcontroller to control the solenoid valves. The number of switches drives the number of microcontroller inputs used for switches. The maximum total number of I/O's used for this embodiment, at this point in time, is 16. In this case, the user can directly control all three zones (firmer/softer), has a toggle switch for massage on/off and a rocker switch for massage intensity (9 for switches, 6 for valves, 1 for pump). By embedding some functions and only allowing the user to directly control two of the three zones, this number can be reduced.

The massage control sequence is established by depressing one or more of the switches and depending upon the input to the microcomputer 16 an automatic control sequence is established by input signals from manually operated inflate or deflate switches and wherein the microcomputer is preprogrammed to provide a timed inflate and exhaust of the air cells.

For example, an automatic massage sequence can include the fill and exhaust periods are application specific and depend on the size (volume) of the cells, the length of the hoses and the cell position relative to the seat surface. As currently configured, the time's range from 0.25 second to 5 seconds. However, the maximum time may be increased for other applications, e.g., home seating.

The input signal will produce a preprogrammed control timed control sequence of the sets of dual valves 126, 128, 130. For example, the sequence can be as follows:

| Step | Action-Other Intensity | Action-Min. Intensity |
|---|---|---|
| | Deflate All | |
| 1 | Start pump | |
| 2 | I (I) | I (I) |
| 3 | D (1), I (2) | D (1), I (2) |
| 4 | D (2), I (3) | D (2), I (3) |
| 5 | D (3), I (2) | D (3) |
| 6 | D (2) | Repeat 2 through 5 |
| 7 | Repeat 2 through 6 | |

I = Inflate;
D = Deflate;
n = 1.2.3 = zone number

The massage speed is affected by the massage intensity setting which is graded as firmer or softer. The softest setting is the “fastest” and requires the modified sequence as shown in the right-most column of the table. So, the right hand action column corresponds to the minimum intensity and the left-hand action column corresponds to all other intensities.

The switches can be ordinary pressure switches; toggle type switches or rocker arm switches.

An automatic massage control is initiated by a microprocessor in response to control signals from a combination of manual control switch techniques as follows:

| | |
|---|---|
| Technique 1 | Single, momentary, push-button switch with a toggle |
| | function. Pushing switch once initiates massage, pushing |
| | switch a second time halts massage. |
| Technique 2 | Two position, momentary rocker switch. Pushing one side |
| | of switch turns massage on and pushing the other side of |
| | the switch turns massage off. |
| Technique 3 | Embedded switch function: pressing two switches at one |
| | time initiates massage and pressing the opposite two |
| | switches halts massage, e.g., press inflate zone 1 and inflate |
| | zone 2 simultaneously to start massage and press deflate |
| | zone 1 and deflate zone 2 simultaneously to halt massage. |

In all cases, when massage is halted, either through timing out or by the user selecting the proper switch(es), the system performs a deflate all and then inflates the support zones to their setting before massage is initiated. When massage is initiated, all zones are deflated before the actual massage sequence begins.

For massage intensity, a two-position momentary rocker switch is used. The options are to increase or decrease massage intensity. Increasing massage intensity, increases the inflation/deflation time to increase the resulting pressure in the cells but also slows the progress from one cell to the next. Decreasing massage intensity, decreases the inflation/deflation time to decrease the resulting pressure in the cells and also speeds the progress from one cell to the next. The speed impact is a byproduct of the intensity changes while the pressure increase/decrease is the goal of the change.

While such control is advantageous for controlling most of the air cells in the seat structure, in accordance with the present invention it would also be desirable to operate certain of the cells so as to serve as massage units within the seat structure.

Additionally, in accordance with the present invention, air cells forming the contouring elements of the seat back and bottom or in the support surface of a bed structure have their pressure controlled in response to the selected type of massage control.

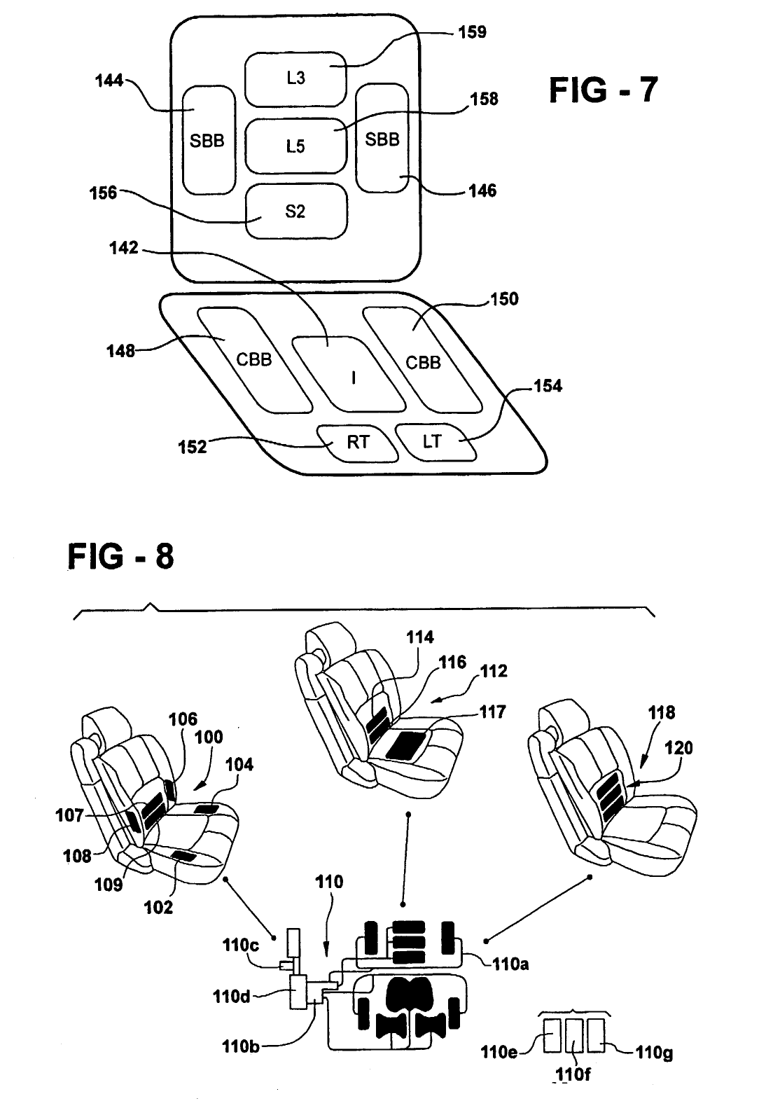

In the embodiment shown in FIG. 7 a seating module 140 and controller that can provide bundled control module and air cell zone combinations including 2-zone combinations having seat S2/L5 air cell combinations; I/L5/3 air cell combinations; seat S2/SBB air cell combinations; I/seat S2 air cell combinations; L5/3/SBB combinations; I/SBB; I/CBB; RT/LT. Three zone combinations can include (S2,L5,L3); (S22, L5/3. SBB); (L5/3,SBB,I); L5/3,SBB,CBB); (I,RT,LT);(I,SBB,CBB); (RT,LT,CBB). Four zone combinations can include (S2,L5,L3,SBB); (S2,L5/3,SBB,CBB); (S2, L5/3,LT,RT); (I,LT,RT,L5/3) and(I,LT,RT,S2).

Codes for each of the aforedescribed air cell zone and combinations are as follows:

I—Ischial 142

SBB—Seat back bolster side air cells 144,146

CBB—Cushion bolster side air cells 148, 150

RT—Right thigh support air cell 152

LT—Left thigh support air cell 154

S2—Iliac support air cell 156

L5—Lower lumbar support air cell 158

L3—Middle lumbar support air cell 159

The packaging of such air cells and control module enables the supplier to control the function and operational packages on a health and performance basis based upon desired objectives that they are designed to satisfy. Thus, air cells positioned to support the ischial and lumbar and seat iliac of a user can satisfy health features including posture and circulation; bolster and seat features can satisfy high performance vehicle seating requirements; and seat and thigh support features can satisfy comfort requirements. Combinations of health, comfort and performance are also possible.

More particularly a system is configured to provide both support of an occupant for seating comfort or to improve user health by spinal and pelvic adjustments.

Another advantage of the aforesaid modular and selectable air cell arrangements is that a vehicle manufacturer no longer will be required to have a single dedicated system build to print constraint. Hence, in the past, the seating objectives for a given seat or platform was clearly defined and set well in advance of a production phase of a seating program. Consequently, the seat comfort control features that the end user, e.g., the automobile consumer, has been fixed and typically very limited in number. At the present time it is quite unusual if more than two-seat comfort system options are available to an end-user of a single vehicle or model.

The aforesaid system provides a greater degree of customization for such end users. The systems of FIGS. 7 and 8 will allow the vehicle manufacturer to activate a limited number of zones throughout the seat surface. The seat will be assembled with air cells placed in a number of key zones potentially numbering more than a dozen. A control module and pump will be located within the seat and they will be designed to control a limited number of zones, typically three or four depending on the switch configuration that is selected as described above. The manufacturer or dealership will be able to activate particular zones by connecting the hoses attached to given zones to the limited number of outputs from a selected control module that will be configured to operate the zones selected. Such connection step or process can take place at the seat assembly plant, the automobile manufacturing facility, the dealership or could even be performed by the end-user as long as instructions and access is provided.

The inventive process is providing a seat or automobile manufacturer a preprogrammed control module; a number of air cell arrays in the seat and a connection process in which a limited number of hose connections on the selected control module are selectively connected to selected ones of the air cell zones or arrays including the novel steps of linking selected zones to a specified number of control module outputs.

While the inventive process of linking such specified modules with such specified zones of multiple zone air cell arrays is applicable to a wide range of support systems including automotive seating; home furniture including beds; airline seating; heavy truck seating; office furniture and medical beds and chairs.

What is claimed is:

1. A vehicle seat arrangement having a plurality of air cells therein for supporting a user characterized by:
a plurality of air cells with expandable chambers comprising a fixed array; a controller for connecting said plurality of air cells and a fluid supply system that includes fittings for cutting off one or more of the air cells from the controller to conform the fixed array of air cells to one of a plurality of vehicle types.

2. The vehicle seat arrangement of claim 1 further characterized by said fixed array being part of a modular seating unit; said modular seating unit including a pump, supply hoses, and a wiring harness; a connection for securing said wiring harness to a controller; said controller comprising one of a plurality of different function controllers selected to provide different user preference operation of said modular seating unit.

3. The vehicle seat arrangement of either claim 1 or claim 2 wherein said controller is programmed to have target pressures attained by using a programmed time of inflation or deflation of the expandable chambers as established by desired program sequences of operation by the controller.

5. The vehicle seat arrangement of claim 3 wherein the valves are provided and said controller is programmed to have a programmed time of inflation or deflation established by sequentially activating said valves individually and energizing said at least one pump for predetermined periods, and varying the number and location of the expandable chambers pressurized in the more than one expandable chambers producing localized pressures exerted on a supported member;

6. The vehicle seat arrangement of claim 1 including a pressure source and an exhaust system to provide a pneumatically controlled support surface for the seating or body support system and wherein the massage movement includes a sequence of inflate and deflate between the respective expandable chambers of the more than one expandable chambers so as to provide concentrated massage while maintaining a directional movement of the expandable chambers producing the massage action.

7. The vehicle seat arrangement of claim 6 including providing the more than one expandable chambers as a series of expandable chambers and providing more than one user selected massage type and a preprogrammed manner of individual expandable chamber inflation and deflation to produce either a pulse type control of individual expandable chambers in both inflate and deflate steps through the series of expandable chambers so as to produce the aforesaid concentrated massage action.

8. The vehicle seat arrangement of claim 1 further characterized by providing an inflate switch and a deflate switch and wherein the control sequence is initiated by signals from said inflate and deflate switches to said controller and wherein a manual inflate or deflate control is established by inputting the controller with input signals from manual operation of the inflate or deflate switches and wherein the controller is preprogrammed to provide a timed inflate and exhaust of the expandable chambers.

9. The vehicle seat arrangement of claim 1 further characterized by providing one expandable chamber as a lower lumbar expandable chamber, an upper lumbar expandable chamber and a middle expandable chamber and wherein the pressure source and exhaust system are controlled by an automatic controller controlled sequence of massage in which the sequence includes fully inflating the lower lumbar expandable chamber; then transferring the air from such lower lumbar expandable chamber to the upper lumbar expandable chamber and then to the middle or third expandable chamber and following such inflation deflating each of the multiple expandable chambers from the upper expandable chamber down to the lower expandable chamber and repeating the aforesaid automatic massage for a timed period.

10. The vehicle seat arrangement of claim 9 further characterized by depressing the switches for a predetermined period of time to stop the automatic massage action.

11. The vehicle seat arrangement of claim 1 further characterized by to providing sensors and other switches and a controller operative in response to multiple input signals including one or more of an occupant detection condition; a temperature condition; system power-up; on-off switch and a system override switch.

12. The vehicle seat arrangement of claim 1 further characterized by a providing a pressurized manifold; providing dual valves between the pressurized manifold and the one or more expandable chambers for controlling air flow from a supply manifold or to exhaust the one or more expandable chambers.

13. The vehicle seat arrangement of claim 1 further characterized by the pressure source including a pump supplying the manifold; and operating the pump during exhaust from the one or more expandable chambers to back pressure the manifold.

14. The vehicle seat arrangement of claim 12 including providing the one or more expandable chambers as at least first second and third expandable chambers; providing a massage sequence including deflating all of the expandable chambers; connecting the pressurized manifold to the first expandable chamber; deflating the first expandable chamber while inflating the second expandable chamber; deflating the second expandable chamber while inflating the third expandable chamber; deflating the third expandable chamber while inflating the second expandable chamber and deflating the second expandable chamber; repeating the aforesaid massage sequence.

15. The vehicle seat arrangement of claim 12 including providing the one or more expandable chambers as at least first second and third expandable chambers; providing a massage sequence including deflating all of the expandable chambers; connecting the pressurized manifold to the first expandable chamber to inflate the first expandable chamber; deflating the first expandable chamber while inflating the second expandable chamber; deflating the second expandable chamber while inflating the third expandable chamber; deflating the third expandable chamber and repeating the aforesaid massage sequence.
